(19) United States
(12) Patent Application Publication
(10) Pub. No.: US 2025/0303339 A1
(43) Pub. Date: Oct. 2, 2025

(54) Skimmer Separator System for Cotton Processing

(71) Applicant: Ramsey Air Management Inc., Lubbock, TX (US)

(72) Inventors: Lloyd Todd Ramsey, Lubbock, TX (US); Robert Taylor Jameson, Lubbock, TX (US); Joe Longoria, Lubbock, TX (US); Stephen Brookshire, Lubbock, TX (US)

(21) Appl. No.: 19/098,439

(22) Filed: Apr. 2, 2025

Related U.S. Application Data
(60) Provisional application No. 63/573,408, filed on Apr. 2, 2024.

(51) Int. Cl. B01D 46/681; B01D 45/04; B01D 45/18; B01D 46/00; D01B 1/04

(52) U.S. Cl. CPC B01D 46/681; B01D 45/04; B01D 45/18; B01D 46/0043; D01B 1/04

(57) ABSTRACT

An improved skimmer separator system for separating cotton from an airstream is disclosed. Comprising the improved skimmer separator system comprises a main body, an elbow duct an elbow inlet, a drum wiper assembly, a hopper chamber. The main body housing internal components for separating cotton. The elbow duct positioned within the main body, configured to redirect the airstream from a substantially horizontal trajectory to a substantially vertical trajectory through the elbow inlet. A screen is positioned at an inner corner of the elbow duct to allow air to pass through while retaining cotton. The drum wiper assembly configured to scrape the screen to prevent cotton buildup. A skimmer chamber connected to the elbow duct via an elbow wiper outlet, configured to capture heavier materials. The hopper chamber connected to the elbow duct via an elbow lower outlet, configured to collect lighter cotton descending by gravity.

### CROSS-REFERENCE TO RELATED APPLICATIONS

This application claims benefit to U.S. provisional patent application No. 63/573,408 filled on 2024 Apr. 2.

### STATEMENT REGARDING FEDERALLY SPONSORED RESEARCH OR DEVELOPMENT (IF APPLICABLE)

Not applicable.

### REFERENCE TO SEQUENCE LISTING, A TABLE, OR A COMPUTER PROGRAM LISTING COMPACT DISC APPENDIX (IF APPLICABLE)

Not applicable.

### BACKGROUND OF THE INVENTION

In the realm of cotton processing, particularly within the cotton ginning industry, the separation of cotton fibers from seeds and conveying air is a critical step that significantly impacts the quality and efficiency of downstream textile manufacturing. Traditional cotton separators, as documented in the Cotton Ginners' Handbook (Agricultural Handbook No. 503, Chapter 5: Materials Handling), rely on airflow to transport and separate fibers. The first four figures in this application are taken from the Cotton Ginner's Handbook at pages 43-44; viz., FIG. 1A corresponding to FIG. 4-1 of the handbook, FIG. 1B to 4-3, FIG. 2A to 4-4, and FIG. 2B to 4-6. These figures illustrate

[symbol]

Traditional cotton separators employ designs such as those with multiple screen sections and cylinders (FIG. 4-1), reversed curved screens with revolving reels (FIG. 4-3), curved screens with revolving reels (FIG. 4-4), and curved grid-bar screens (FIG. 4-6). These conventional systems utilize stationary screens to capture cotton while allowing air to pass through, often incorporating cleaning mechanisms like rubber viper flights on revolving reels or the wiping action of incoming cotton and air. However, a persistent challenge with these designs is the accumulation of cotton on the screens, which obstructs airflow, reduces separation efficiency, and necessitates frequent system shutdowns for manual cleaning. The handbook notes that high-capacity ginning exacerbates these issues, with uneven material flow and negative pressure contributing to screen clogging, leading to increased labor costs and operational downtimes.

The Cotton Ginners' Handbook further details that separators of the first and second types, which employ rubber wipers on rotating reels, require periodic inspection and adjustment due to wear, yet these wipers can become set or damaged, failing to prevent blockages when air leakage occurs from improper sealing. Similarly, the fourth type, using grid-bar screens cleaned by material flow, relies on precise adjustments of spreaders for even distribution, but remains vulnerable to disruptions in continuous operation. These limitations highlight a critical need for an improved separation system capable of maintaining consistent airflow and minimizing maintenance interventions.

The present invention introduces an improved skimmer separator system that overcomes these deficiencies by integrating a skimmer with a novel elbow design in the airstream path. This system redirects the flow of air and cotton from a primarily horizontal trajectory through said air-cotton input passage to a vertical descent past said skimmer and screen, effectively preventing screen blockage. Said elbow portion, positioned at approximately a 90-degree angle, facilitates this transition, with said screen located at the inside corner to allow air to escape through said air exit passage. Meanwhile, said skimmer, configured as a rotating wheel with a rubber brush, scrapes said screen to dislodge cotton, directing it into said chute within said cotton exit passage, where it descends by gravity without airflow interference. In one embodiment, said rubber brush can rotate parallel to the airflow, ensuring efficient screen cleaning and maintaining system clarity without manual intervention. This design marks a significant advancement over the prior art, promising reduced maintenance, enhanced productivity, and a more reliable solution for cotton ginning.

No prior art is known to the Applicant.

### BRIEF SUMMARY OF THE INVENTION

An improved skimmer separator system 300 for separating cotton from an airstream is disclosed. Comprising said improved skimmer separator system 300 comprises a main body 302, an elbow duct 500 an elbow inlet 600, a drum wiper assembly 506, a hopper chamber 618. Said main body 302 housing internal components for separating cotton. The elbow duct 500 positioned within said main body 302, configured to redirect said airstream from a substantially horizontal trajectory to a substantially vertical trajectory through said elbow inlet 600. A screen 606 is positioned at an inner corner of said elbow duct 500 to allow air to pass through while retaining cotton. Said drum wiper assembly 506 configured to scrape said screen 606 to prevent cotton buildup. A skimmer chamber 616 connected to said elbow duct 500 via an elbow wiper outlet 602, configured to capture heavier materials. Said hopper chamber 618 connected to said elbow duct 500 via an elbow lower outlet 604, configured to collect lighter cotton descending by gravity. Wherein said improved skimmer separator system 300 prevents screen blockages by redirecting cotton flow and maintaining airflow continuity.

A skimmer separator system for cotton processing is disclosed. Comprising the improved skimmer separator system 300 configured to separate cotton from an airstream without clogging. An inlet duct 612 having an inlet passage 614, configured to introduce a cotton-airstream mixture into said system. The elbow duct 500 connected to said inlet passage 614 via the elbow inlet 600, configured to redirect said mixture from a horizontal to a vertical trajectory. The screen 606 positioned within said elbow duct 500, configured to separate air from cotton. The skimmer chamber 616 connected to said elbow duct 500 via the elbow wiper outlet 602, configured to collect heavier materials. The hopper chamber 618 connected to said elbow duct 500 via the elbow lower outlet 604, configured to collect lighter cotton. A lower skimmer outlet 620 connecting said skimmer chamber 616 to said hopper chamber 618, configured to transfer skimmed materials. The drum wiper assembly 506 configured to clear said screen 606 and direct cotton into said hopper chamber 618. Wherein said improved skimmer separator system 300 maintains continuous operation by preventing fibrous buildup on said screen 606.

A method of use 800 for improved skimmer separator system 300 for separating cotton from an airstream is disclosed. Comprising introducing a cotton-airstream mixture into the inlet duct 612 through the inlet passage 614. Redirecting said mixture from a horizontal to a vertical trajectory using the elbow duct 500 via the elbow inlet 600. Separating air from cotton using the screen 606 positioned at an inner corner of said elbow duct 500. Capturing heavier materials in the skimmer chamber 616 through the elbow wiper outlet 602. Collecting lighter cotton in the hopper chamber 618 through the elbow lower outlet 604. Scraping said screen 606 with the drum wiper assembly 506 to prevent cotton buildup. Discharging air and debris through a skimmer outlet 504 connected to said skimmer chamber 616. Wherein said method prevents screen blockages and ensures continuous cotton processing.

### BRIEF DESCRIPTION OF THE SEVERAL VIEWS OF THE DRAWING

FIG. 1A illustrates a perspective view of a conventional separator system 100 with multiple screen sections and cylinders.

FIG. 1B illustrates a perspective view of a conventional separator system 120 with a reversed curved screen and revolving reel.

FIG. 2A illustrates a perspective view of a conventional separator system 200 with a curved screen and revolving reel.

FIG. 2B illustrates a perspective view of a conventional separator system 220 with a curved grid-bar screen.

FIG. 3 provides a perspective overview of an improved skimmer separator system 300, highlighting the arrangement of its key components.

FIG. 4A, 4B, 4C three elevated views of the [improved skimmer separator system 300 along with two section cut lines for deeper analysis in later figures.

FIG. 5 shows a disassembled view of the improved skimmer separator system 300, with parts of the body removed to reveal internal elements.

FIGS. 6A and 6B provide further insight into the improved skimmer separator system 300. FIG. 6A illustrates a perspective lower view of the fully assembled system, and FIG. 6B uses section cut line 400 for a cross-sectional look at airflow and component interactions.

FIG. 7 details the drum wiper assembly 506, breaking down its parts and their contributions to system efficiency.

FIG. 8 illustrates a process flow chart detailing the initial steps of a method of use 800 the improved skimmer separator system 300 to separate cotton from an airstream.

FIG. 9 illustrates a process flow chart detailing subsequent steps of said method of use 800 the improved skimmer separator system 300, focusing on the handling of heavier materials and final discharge.

### DETAILED DESCRIPTION OF THE INVENTION

The following description is presented to enable any person skilled in the art to make and use the invention as claimed and is provided in the context of the particular examples discussed below, variations of which will be readily apparent to those skilled in the art. In the interest of clarity, not all features of an actual implementation are described in this specification. It will be appreciated that in the development of any such actual implementation (as in any development project), design decisions must be made to achieve the designers' specific goals (e.g., compliance with system-and business-related constraints), and that these goals will vary from one implementation to another. It will also be appreciated that such development effort might be complex and time-consuming, but would nevertheless be a routine undertaking for those of ordinary skill in the field of the appropriate art having the benefit of this disclosure. Accordingly, the claims appended hereto are not intended to be limited by the disclosed embodiments, but are to be accorded their widest scope consistent with the principles and features disclosed herein.

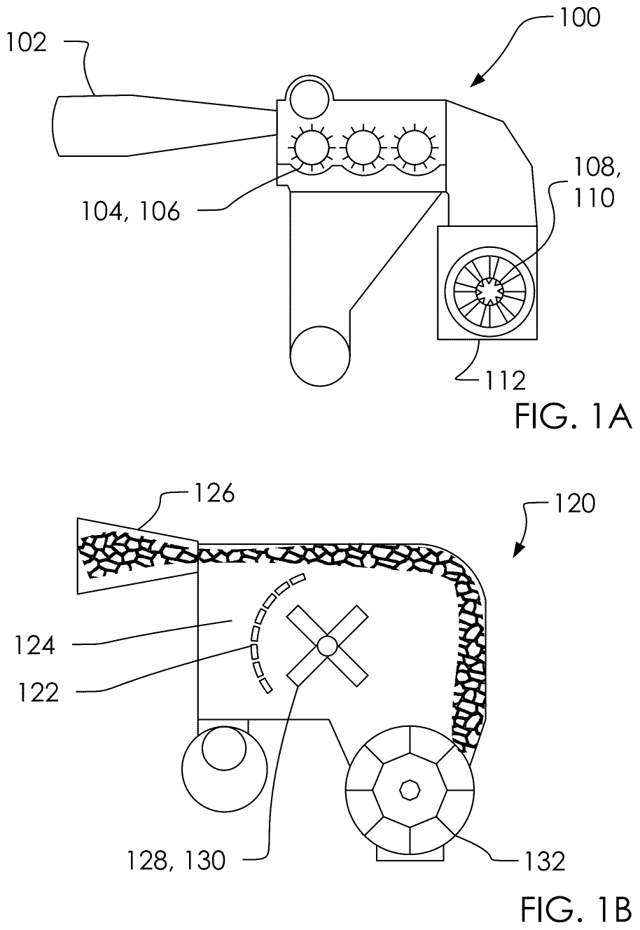

FIG. 1A illustrates a perspective view of a conventional separator system 100 with multiple screen sections and cylinders.

In one embodiment, said conventional separator system 100 can be configured to receive seed cotton through a conveyor inlet 102 and direct it toward a screen assembly 104 comprising multiple screen sections 106. Said screen assembly 104 can be positioned to allow air to pass through said screen sections 106 while capturing cotton fibers, with a cylinders 108 equipped with rubber viper flights 110 rotating to clean said screen sections 106. Said cylinders 108 can facilitate the movement of cotton along said screen assembly 104, directing it toward a discharge outlet 112 for further processing.

FIG. 1B illustrates a perspective view of a conventional separator system 120 with a reversed curved screen and revolving reel.

In one embodiment, said conventional separator system 120 can include a reversed curved screen 122 positioned within an airflow conduit 124 to intercept seed cotton from a conveyor inlet 126. Said reversed curved screen 122 can allow air to escape while retaining cotton, with a revolving reel 128 equipped with rubber viper flights 130 rotating to scrape said reversed curved screen 122 and prevent buildup. Said revolving reel 128 can direct cleaned cotton toward a discharge chute 132 for gravity-assisted removal.

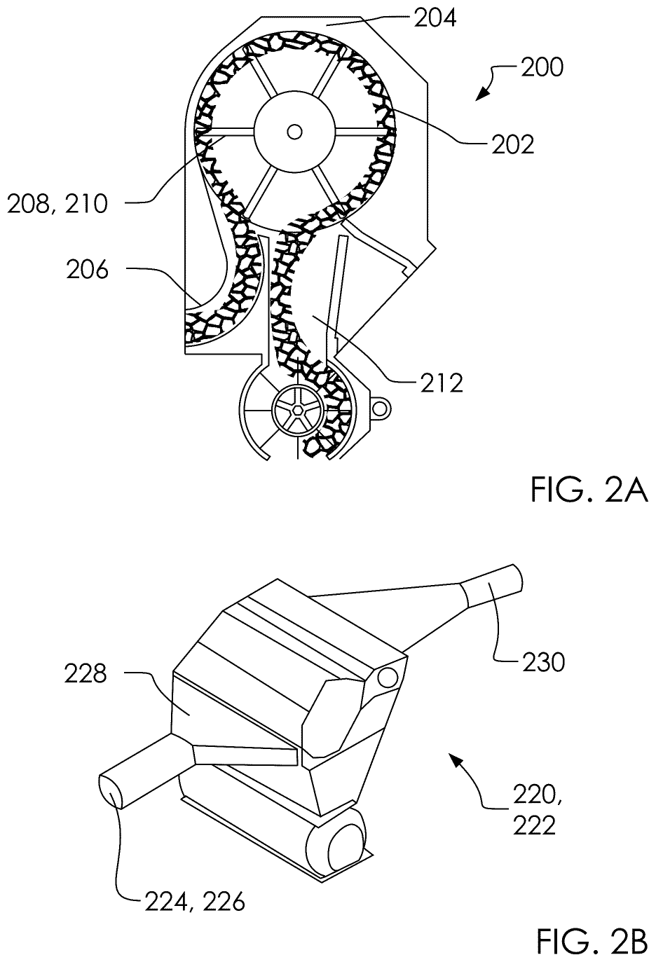

FIG. 2A illustrates a perspective view of a conventional separator system 200 with a curved screen and revolving reel.

In one embodiment, said conventional separator system 200 can comprise a curved screen 202 situated within an airflow path 204 to separate cotton from conveying air entering through a conveyor inlet 206. Said curved screen 202 can be cleaned by a revolving reel 208 fitted with rubber viper flights 210, which rotate to dislodge accumulated cotton and guide it toward a discharge outlet 212. Said revolving reel 208 can operate continuously to maintain airflow through said curved screen 202.

FIG. 2B illustrates a perspective view of a conventional separator system 220 with a curved grid-bar screen.

In one embodiment, said conventional separator system 220 can feature a curved grid-bar screen 222 positioned diagonally within an airflow channel 224 to receive seed cotton from a conveyor inlet 226. Said curved grid-bar screen 222 can be cleaned by the wiping action of incoming cotton and air, with a dovetail spreader 228 adjusting the flow to ensure even distribution across said curved grid-bar screen 222. Said conventional separator system 220 can direct separated cotton to a discharge chute 230 for removal.

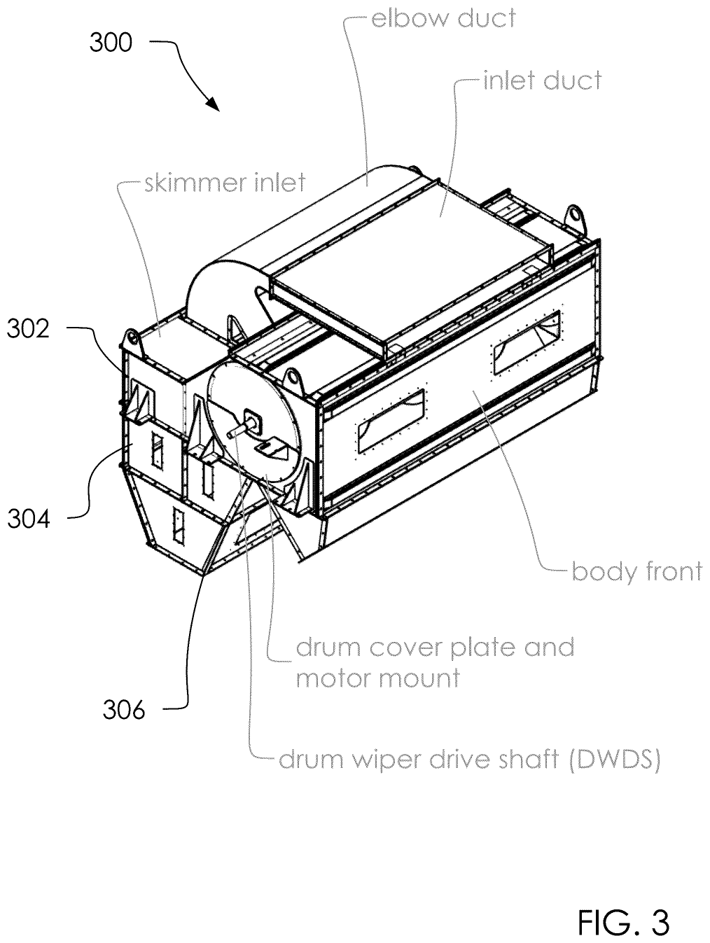

FIG. 3 provides a perspective overview of an improved skimmer separator system 300, highlighting the arrangement of its key components.

In this embodiment, the system includes a main body 302, a bottom body 304, and a hopper assembly 306. The main body 302 encases the internal mechanisms that separate cotton from an airstream, while the bottom body 304, attached beneath it, features outlets for processed materials. Connected to the bottom body 304, the hopper assembly 306 gathers and directs the separated cotton. This design tackles a major flaw in traditional separators—screen blockage—by integrating a skimmer and an elbow in the airflow path, set at roughly a 90° angle. This setup disrupts the cotton flow, shifting it from a primarily horizontal to a vertical trajectory, preventing accumulation on the screen. Unlike older systems that often clogged and required frequent manual cleaning, this innovation ensures consistent operation and boosts efficiency in cotton processing.

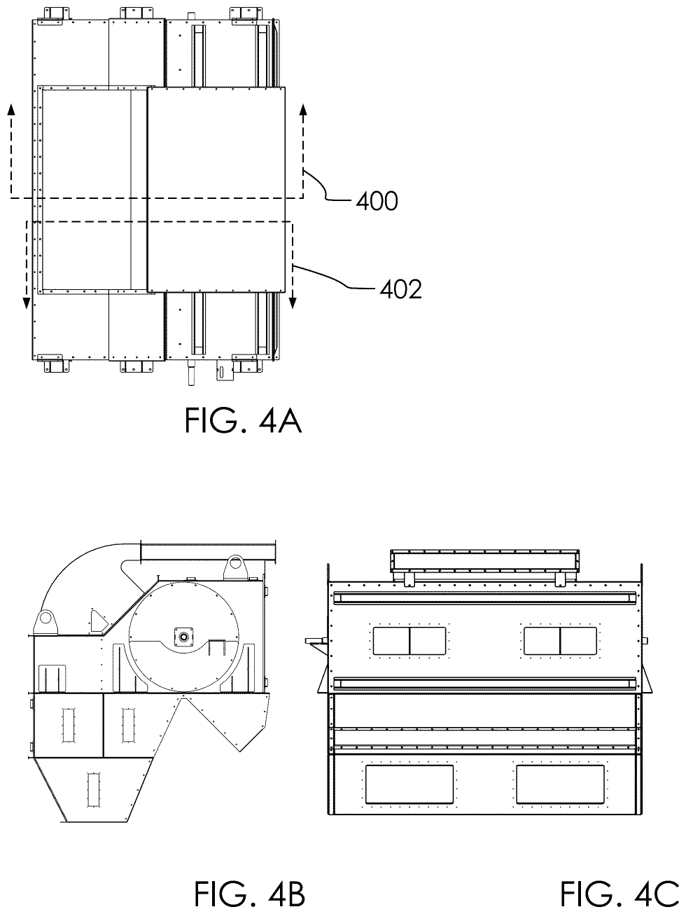

FIG. 4A, 4B, 4C three elevated views of the [improved skimmer separator system 300 along with two section cut lines for deeper analysis in later figures.

The section cut line 400 is placed to expose the elbow and skimmer assembly in a cross-sectional view, while a section cut line 402 focuses on the drum wiper assembly's interaction with the screen. These perspectives showcase the spatial layout and functional harmony of the components, emphasizing the elbow and skimmer's role in preventing fibrous buildup on the screen. This addresses a frequent problem in prior art separators, where blockages often halted operations, demonstrating the system's practical design improvements.

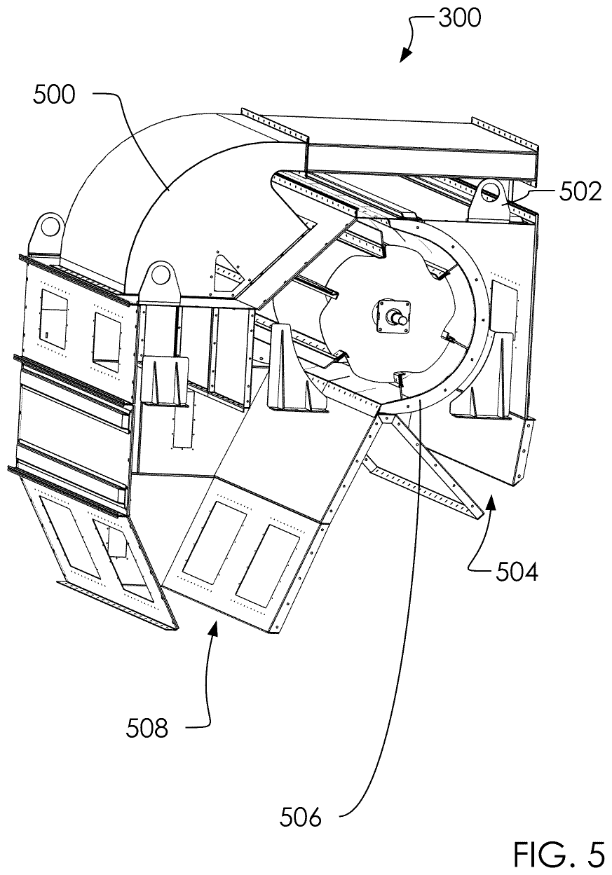

FIG. 5 shows a disassembled view of the improved skimmer separator system 300, with parts of the body removed to reveal internal elements.

Said improved skimmer separator system 300 can comprise an elbow duct 500, which redirects the cotton-laden airstream from horizontal to vertical; a lifting lug 502, mounted on the main body 302 for handling during installation or maintenance; a skimmer outlet 504 configured to discharge air and debris that escapes through the screen; a drum wiper assembly 506, located inside the main body 302 to keep the screen clear of cotton buildup; and a hopper outlet 508. This view highlights the system's clever engineering, particularly the elbow-skimmer synergy, which ensures smooth cotton separation and airflow continuity, outperforming traditional designs prone to obstruction.

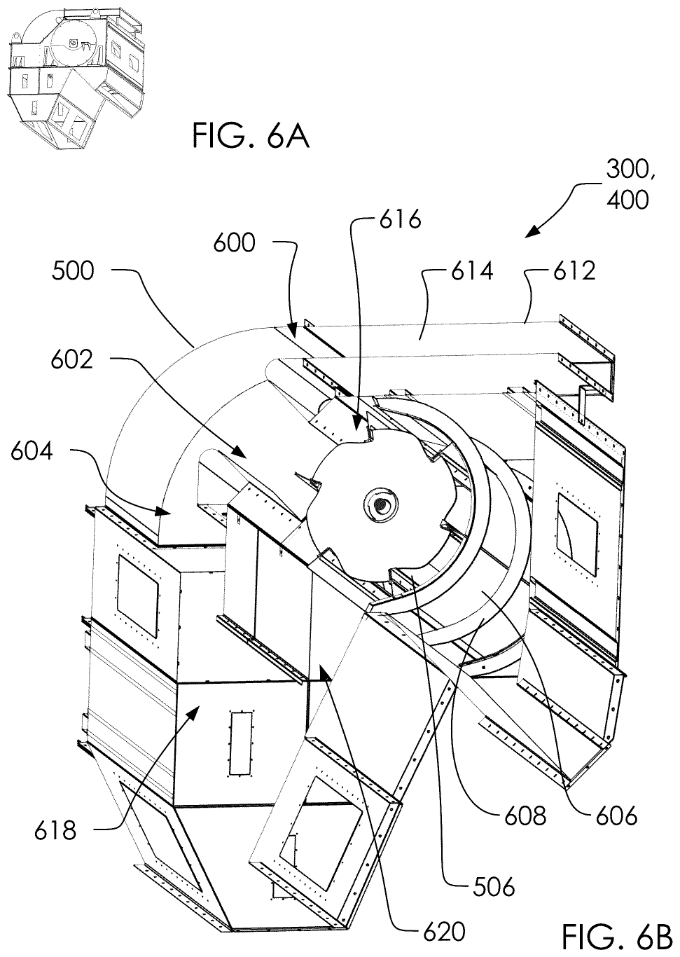

FIGS. 6A and 6B provide further insight into the improved skimmer separator system 300. FIG. 6A illustrates a perspective lower view of the fully assembled system, and FIG. 6B uses section cut line 400 for a cross-sectional look at airflow and component interactions.

The elbow inlet 600 receives the horizontal cotton-airstream mix, which the elbow duct 500 then redirects. an elbow wiper outlet 602 captures heavier fibers, a unique feature sorting materials by weight, while an elbow lower outlet 604 channels lighter cotton downward. At the elbow's inner corner, a screen 606, reinforced by screen ribs 608, filters air while retaining cotton, and the drum wiper assembly 506 scrapes it clean.

In one embodiment, drum wiper assembly 506 is configured to clear the screen 606, guiding cotton into a dropper chute without blocking airflow. This shift from horizontal to vertical flow is configured to minimize clogs and enhancing performance.

In one embodiment, said conventional separator system 100 can comprise elbow duct 500, an inlet duct 610, said drum wiper assembly 506, an inlet duct 612 having an inlet passage 614. Said elbow duct 500 can comprise said elbow inlet 600, said elbow wiper outlet 602 and said elbow lower outlet 604. Wherein, elbow inlet 600 is connected to said inlet passage 614 of said inlet duct 612; said elbow wiper outlet 602 is connected to a skimmer chamber 616, and elbow lower outlet 604 is connected to a hopper chamber 618.

In one embodiment, said skimmer chamber 616 can connect to skimmer outlet 504 through screen 606 and to hopper chamber 618 through a lower skimmer outlet 620.

Accordingly, said improved skimmer separator system 300 can be configured to channel a cotton mixture into inlet duct 612 separate a lighter material directly into elbow lower outlet 604 and hopper chamber 618, a heavier material into elbow wiper outlet 602 and said skimmer chamber 616, to skim are remove cotton from skimmer chamber 616 into lower skimmer outlet 620 and hopper chamber 618, and allow an air and debris to exit through screen 606 and skimmer outlet 504. By accounting for air movement and clearing said screen 606, said improved skimmer separator system 300 is configured to efficiently separate cotton without clogging or human intervention.

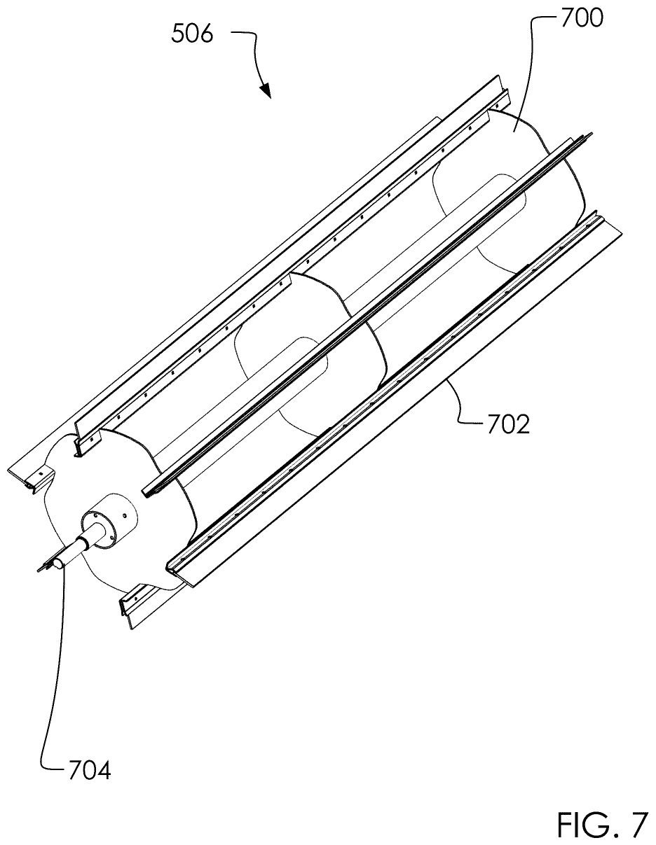

FIG. 7 details the drum wiper assembly 506, breaking down its parts and their contributions to system efficiency.

In one embodiment, said drum wiper assembly 506 can comprise one or more support wheels 700 aligned parallel to the airflow, and a plurality of brush assemblies 702 arranged around its edge to scrape cotton off the screen 606, and a drive shaft 704 configured to receive drive power from a motor and for powering said one or more support wheels 700 at an optimal cleaning speed. An alternative version might use a rubber brush or a rubber wiper for said plurality of brush assemblies 702 scraping.

The drum wiper assembly 506 keeps the screen 606 clear during operation, efficiently removing fibrous material and maintaining airflow. This continuous cleaning mechanism sets the system apart from traditional separators, which often demanded manual intervention due to blockages, ensuring smoother cotton processing.

Overall, the improved skimmer separator system 300 excels over prior art with its elbow-skimmer configuration, which prevents screen blockages, redirects cotton efficiently from horizontal to vertical flow, and employs a gravity-assisted dropper chute. These advancements deliver uninterrupted processing, overcoming longstanding hurdles in cotton ginning technology and enhancing operational reliability.

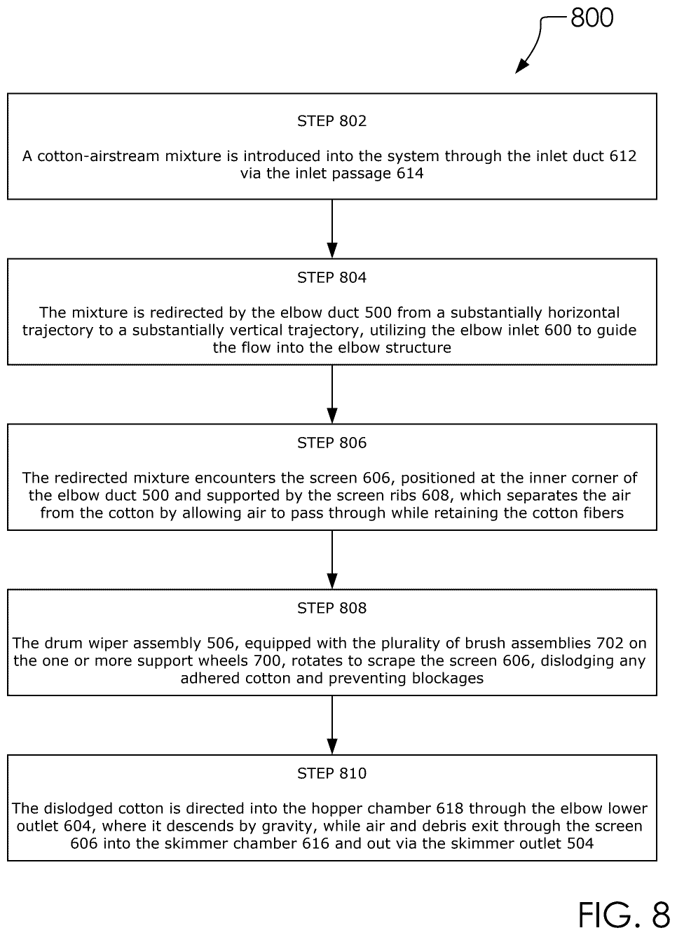

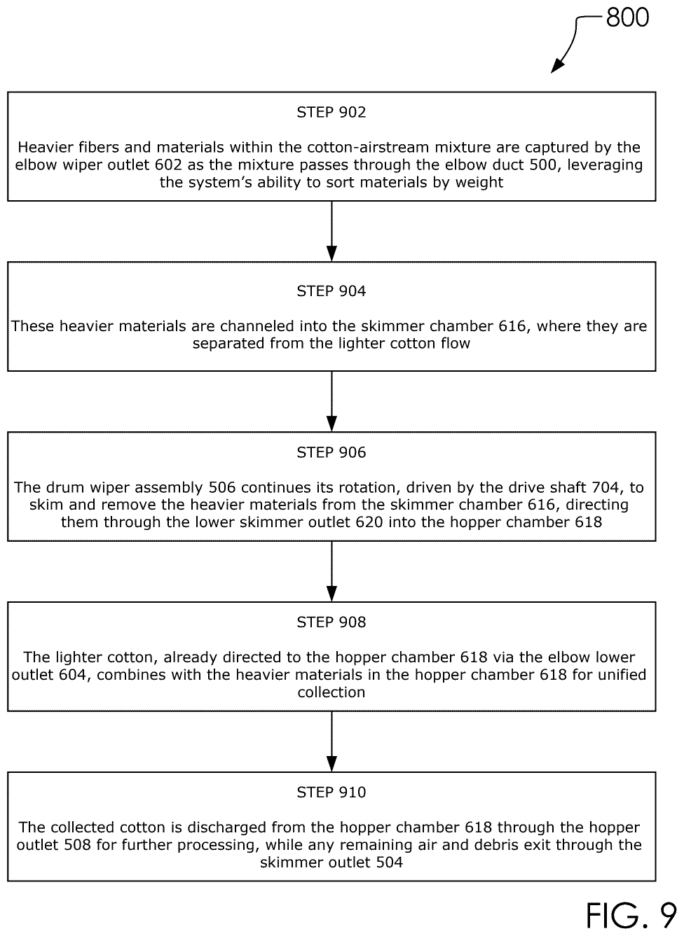

Below is the new section for the Detailed Description (DD) covering the method of use process flow charts for FIGS. 8 and 9, using the bracket notation as specified. This section focuses on the operational steps of the improved skimmer separator system 300, aligning with the placeholders in the current figures (STEP 802 through STEP 910). The description integrates the system's components and their functions to outline a clear method of use, which can support an independent method claim set.

FIG. 8 illustrates a process flow chart detailing the initial steps of a method of use 800 the improved skimmer separator system 300 to separate cotton from an airstream.

In one embodiment, the method begins with STEP 802, where a cotton-airstream mixture is introduced into the system through the inlet duct 612 via the inlet passage 614. At STEP 804, the mixture is redirected by the elbow duct 500 from a substantially horizontal trajectory to a substantially vertical trajectory, utilizing the elbow inlet 600 to guide the flow into the elbow structure. In STEP 806, the redirected mixture encounters the screen 606, positioned at the inner corner of the elbow duct 500 and supported by the screen ribs 608, which separates the air from the cotton by allowing air to pass through while retaining the cotton fibers. During STEP 808, the drum wiper assembly 506, equipped with the plurality of brush assemblies 702 on the one or more support wheels 700, rotates to scrape the screen 606, dislodging any adhered cotton and preventing blockages. Finally, in STEP 810, the dislodged cotton is directed into the hopper chamber 618 through the elbow lower outlet 604, where it descends by gravity, while air and debris exit through the screen 606 into the skimmer chamber 616 and out via the skimmer outlet 504. This method ensures efficient separation without the clogging issues common in prior art systems.

FIG. 9 illustrates a process flow chart detailing subsequent steps of said method of use 800 the improved skimmer separator system 300, focusing on the handling of heavier materials and final discharge.

In STEP 902, heavier fibers and materials within the cotton-airstream mixture are captured by the elbow wiper outlet 602 as the mixture passes through the elbow duct 500, leveraging the system's ability to sort materials by weight. At STEP 904, these heavier materials are channeled into the skimmer chamber 616, where they are separated from the lighter cotton flow. In STEP 906, the drum wiper assembly 506 continues its rotation, driven by the drive shaft 704, to skim and remove the heavier materials from the skimmer chamber 616, directing them through the lower skimmer outlet 620 into the hopper chamber 618. During STEP 908, the lighter cotton, already directed to the hopper chamber 618 via the elbow lower outlet 604, combines with the heavier materials in the hopper chamber 618 for unified collection. Finally, in STEP 910, the collected cotton is discharged from the hopper chamber 618 through the hopper outlet 508 for further processing, while any remaining air and debris exit through the skimmer outlet 504. This method highlights the system's innovative design, which prevents screen blockages, efficiently separates materials, and maintains continuous operation, addressing longstanding challenges in cotton ginning technology.

### Parts List:

said conventional separator system 100,
said conveyor inlet 102,
said screen assembly 104,
said screen sections 106,
said cylinders 108,
said rubber viper flights 110,
said discharge outlet 112,
said conventional separator system 120,
said reversed curved screen 122,
said airflow conduit 124,
said conveyor inlet 126,
said revolving reel 128,
said rubber viper flights 130,
said discharge chute 132,
said conventional separator system 200,
said curved screen 202,
said airflow path 204,
said conveyor inlet 206,
said revolving reel 208,
said rubber viper flights 210,
said discharge outlet 212,
said conventional separator system 220,
said curved grid-bar screen 222,
said airflow channel 224,
said conveyor inlet 226,
said dovetail spreader 228,
said discharge chute 230,
said improved skimmer separator system 300,
said main body 302,
said bottom body 304,
said hopper assembly 306,
said section cut line 400,
said section cut line 402,
said elbow duct 500,
said lifting lug 502,
said skimmer outlet 504,
said drum wiper assembly 506,
said hopper outlet 508,
said elbow inlet 600,
said elbow wiper outlet 602,
said elbow lower outlet 604,
said screen 606,
said screen ribs 608,
said inlet duct 610,
said inlet duct 612,
said inlet passage 614,
said skimmer chamber 616,
said hopper chamber 618,
said lower skimmer outlet 620,
said one or more support wheels 700,
said plurality of brush assemblies 702,
said drive shaft 704, and
said method of use 800

The following sentences represent one preferred version of the system and are written in reference to the original claims:

The improved skimmer separator system 300 for separating cotton from an airstream can comprise said improved skimmer separator system 300 comprises the main body 302, the elbow duct 500 the elbow inlet 600, the drum wiper assembly 506, the hopper chamber 618. Said main body 302 housing internal components for separating cotton. The elbow duct 500 positioned within said main body 302, configured to redirect said airstream from a substantially horizontal trajectory to a substantially vertical trajectory through said elbow inlet 600. The screen 606 can be positioned at an inner corner of said elbow duct 500 to allow air to pass through while retaining cotton. Said drum wiper assembly 506 configured to scrape said screen 606 to prevent cotton buildup. The skimmer chamber 616 connected to said elbow duct 500 via the elbow wiper outlet 602, configured to capture heavier materials. Said hopper chamber 618 connected to said elbow duct 500 via the elbow lower outlet 604, configured to collect lighter cotton descending by gravity. Wherein said improved skimmer separator system 300 prevents screen blockages by redirecting cotton flow and maintaining airflow continuity.

The screen 606, supported by screen ribs 608, positioned at an inner corner of said elbow duct 500 to allow air to pass through while retaining cotton.

Said elbow duct 500 can be oriented at approximately a 90-degree angle to facilitate said redirection of said airstream.

The hopper assembly 306 connected to said hopper chamber 618, configured to gather and direct separated cotton for discharge.

Said drum wiper assembly 506 comprises one or more support wheels 700 aligned parallel to said airflow, configured to rotate and clean said screen 606.

Said drum wiper assembly 506 further comprises the plurality of brush assemblies 702 arranged around said one or more support wheels 700, configured to scrape cotton from said screen 606.

Said plurality of brush assemblies 702 comprises rubber brushes to enhance scraping efficiency.

Said drum wiper assembly 506 further comprises the drive shaft 704 configured to power said one or more support wheels 700 at an optimal cleaning speed.

The skimmer outlet 504 connected to said skimmer chamber 616, configured to discharge air and debris that passes through said screen 606.

The hopper outlet 508 connected to said hopper chamber 618, configured to discharge collected cotton for further processing.

A skimmer separator system for cotton processing can comprise the improved skimmer separator system 300 configured to separate cotton from an airstream without clogging. The inlet duct 612 having the inlet passage 614, configured to introduce a cotton-airstream mixture into said system. The elbow duct 500 connected to said inlet passage 614 via the elbow inlet 600, configured to redirect said mixture from a horizontal to a vertical trajectory. The screen 606 positioned within said elbow duct 500, configured to separate air from cotton. The skimmer chamber 616 connected to said elbow duct 500 via the elbow wiper outlet 602, configured to collect heavier materials. The hopper chamber 618 connected to said elbow duct 500 via the elbow lower outlet 604, configured to collect lighter cotton. The lower skimmer outlet 620 connecting said skimmer chamber 616 to said hopper chamber 618, configured to transfer skimmed materials. The drum wiper assembly 506 configured to clear said screen 606 and direct cotton into said hopper chamber 618. Wherein said improved skimmer separator system 300 maintains continuous operation by preventing fibrous buildup on said screen 606.

The main body 302 encasing said elbow duct 500 and said drum wiper assembly 506, configured to support said separation process.

Said elbow duct 500 redirects said mixture at an angle of approximately 90 degrees to minimize screen blockages.
screen ribs 608 supporting said screen 606, configured to maintain structural integrity during operation.

Said drum wiper assembly 506 includes the plurality of brush assemblies 702 configured to rotate parallel to said airflow for efficient screen cleaning.

The lifting lug 502 mounted on the main body 302, configured to facilitate installation and maintenance.

The method of use 800 for improved skimmer separator system 300 for separating cotton from an airstream can comprise introducing a cotton-airstream mixture into the inlet duct 612 through the inlet passage 614. Redirecting said mixture from a horizontal to a vertical trajectory using the elbow duct 500 via the elbow inlet 600. Separating air from cotton using the screen 606 positioned at an inner corner of said elbow duct 500. Capturing heavier materials in the skimmer chamber 616 through the elbow wiper outlet 602. Collecting lighter cotton in the hopper chamber 618 through the elbow lower outlet 604. Scraping said screen 606 with the drum wiper assembly 506 to prevent cotton buildup. Discharging air and debris through the skimmer outlet 504 connected to said skimmer chamber 616. Wherein said method prevents screen blockages and ensures continuous cotton processing.

Skimming said heavier materials from said skimmer chamber 616 through the lower skimmer outlet 620 into said hopper chamber 618 using said drum wiper assembly 506.

Discharging said collected cotton from said hopper chamber 618 through the hopper outlet 508 for further processing.

Scraping said screen 606 involves rotating the plurality of brush assemblies 702 on one or more support wheels 700 within said drum wiper assembly 506, driven by the drive shaft 704.

Various changes in the details of the illustrated operational methods are possible without departing from the scope of the following claims. Some embodiments may combine the activities described herein as being separate steps. Similarly, one or more of the described steps may be omitted, depending upon the specific operational environment the method is being implemented in. It is to be understood that the above description is intended to be illustrative, and not restrictive. For example, the above-described embodiments may be used in combination with each other.

Many other embodiments will be apparent to those of skill in the art upon reviewing the above description. The scope of the invention should, therefore, be determined with reference to the appended claims, along with the full scope of equivalents to which such claims are entitled. In the appended claims, the terms “including” and “in which” are used as the plain-English equivalents of the respective terms “comprising” and “wherein.”

1. A improved skimmer separator system for separating cotton from an airstream, comprising:
said improved skimmer separator system comprises a main body, an elbow duct an elbow inlet, a drum wiper assembly, a hopper chamber;
said main body housing internal components for separating cotton;
an elbow duct positioned within said main body, configured to redirect said airstream from a substantially horizontal trajectory to a substantially vertical trajectory through said elbow inlet;
a screen is positioned at an inner corner of said elbow duct to allow air to pass through while retaining cotton;
said drum wiper assembly configured to scrape said screen to prevent cotton buildup;
a skimmer chamber connected to said elbow duct via an elbow wiper outlet, configured to capture heavier materials;
said hopper chamber connected to said elbow duct via an elbow lower outlet, configured to collect lighter cotton descending by gravity;
wherein said improved skimmer separator system prevents screen blockages by redirecting cotton flow and maintaining airflow continuity.

2. The skimmer separator system of claim 1, wherein:
The screen, supported by screen ribs, positioned at an inner corner of said elbow duct to allow air to pass through while retaining cotton.

3. The skimmer separator system of claim 1, wherein:
said elbow duct is oriented at approximately a 90-degree angle to facilitate said redirection of said airstream.

4. The skimmer separator system of claim 1, further comprising:
a hopper assembly connected to said hopper chamber, configured to gather and direct separated cotton for discharge.

5. The skimmer separator system of claim 1, wherein:
said drum wiper assembly comprises one or more support wheels aligned parallel to said airflow, configured to rotate and clean said screen.

6. The skimmer separator system of claim 5, wherein:
said drum wiper assembly further comprises a plurality of brush assemblies arranged around said one or more support wheels, configured to scrape cotton from said screen.

7. The skimmer separator system of claim 6, wherein:
said plurality of brush assemblies comprises rubber brushes to enhance scraping efficiency.

8. The skimmer separator system of claim 5, wherein:
said drum wiper assembly further comprises a drive shaft configured to power said one or more support wheels at an optimal cleaning speed.

9. The skimmer separator system of claim 1, further comprising:
a skimmer outlet connected to said skimmer chamber, configured to discharge air and debris that passes through said screen.

10. The skimmer separator system of claim 1, further comprising:
a hopper outlet connected to said hopper chamber, configured to discharge collected cotton for further processing.

11. A skimmer separator system for cotton processing, comprising:
an improved skimmer separator system configured to separate cotton from an airstream without clogging;
an inlet duct having an inlet passage, configured to introduce a cotton-airstream mixture into said system;
an elbow duct connected to said inlet passage via an elbow inlet, configured to redirect said mixture from a horizontal to a vertical trajectory;
a screen positioned within said elbow duct, configured to separate air from cotton;
a skimmer chamber connected to said elbow duct via an elbow wiper outlet, configured to collect heavier materials;
a hopper chamber connected to said elbow duct via an elbow lower outlet, configured to collect lighter cotton;
a lower skimmer outlet connecting said skimmer chamber to said hopper chamber, configured to transfer skimmed materials;
a drum wiper assembly configured to clear said screen and direct cotton into said hopper chamber;
wherein said improved skimmer separator system maintains continuous operation by preventing fibrous buildup on said screen.

12. The skimmer separator system of claim 11, further comprising:
a main body encasing said elbow duct and said drum wiper assembly, configured to support said separation process.

13. The skimmer separator system of claim 11, wherein:
said elbow duct redirects said mixture at an angle of approximately 90 degrees to minimize screen blockages.

14. The skimmer separator system of claim 11, further comprising:
screen ribs supporting said screen, configured to maintain structural integrity during operation.

15. The skimmer separator system of claim 11, wherein:
said drum wiper assembly includes a plurality of brush assemblies configured to rotate parallel to said airflow for efficient screen cleaning.

16. The skimmer separator system of claim 11, further comprising:
a lifting lug mounted on a main body, configured to facilitate installation and maintenance.

17. A method of use for improved skimmer separator system for separating cotton from an airstream, comprising:
introducing a cotton-airstream mixture into an inlet duct through an inlet passage;
redirecting said mixture from a horizontal to a vertical trajectory using an elbow duct via an elbow inlet;
separating air from cotton using a screen positioned at an inner corner of said elbow duct;
capturing heavier materials in a skimmer chamber through an elbow wiper outlet;
collecting lighter cotton in a hopper chamber through an elbow lower outlet;
scraping said screen with a drum wiper assembly to prevent cotton buildup;
discharging air and debris through a skimmer outlet connected to said skimmer chamber;
wherein said method prevents screen blockages and ensures continuous cotton processing.

18. The method of use of claim 17, further comprising:
skimming said heavier materials from said skimmer chamber through a lower skimmer outlet into said hopper chamber using said drum wiper assembly.

19. The method of use of claim 17, further comprising:
discharging said collected cotton from said hopper chamber through a hopper outlet for further processing.

20. The method of use of claim 17, further comprising:
scraping said screen involves rotating a plurality of brush assemblies on one or more support wheels within said drum wiper assembly, driven by a drive shaft.
